(19) United States
(12) Patent Application Publication
(10) Pub. No.: US 2023/0030327 A1
(43) Pub. Date: Feb. 2, 2023

(54) TRANSACTION SEQUENCE MODELING FOR FRAUD DETECTION

(71) Applicant: NCR Corporation, Atlanta, GA (US)

(72) Inventors: Shiran Abadi, Tel-Aviv (IL); Itamar David Laserson, Givat Shmeul (IL); Amit Botzer, Haifa (IL)

(21) Appl. No.: 17/389,460

(22) Filed: Jul. 30, 2021

(51) Int. Cl. G06Q 20/40; G06N 20/00; G06Q 20/08; G06Q 20/20

(52) U.S. Cl. CPC G06Q 20/4016; G06N 20/00; G06Q 20/085; G06Q 20/4014; G06Q 20/202; G06Q 20/18

(57) ABSTRACT

The probabilities of transitioning between states of a given transaction sequence for a given transaction are calculated and a non-fraud score is calculated from the probabilities. The non-fraud score is provided to a fraud-detection system for determining whether the transaction sequence is more likely or less likely to be associated with fraud.

### BACKGROUND

Retailers experience significant theft each year perpetrated by their own staff (such as cashiers). Cashiers can commit fraud in a variety of manners, such as by voiding a transaction after completion, opening the cash drawer, and taking the money paid by the customer for the transaction; handing the customer a duplicate receipt and later using the original receipt to perform a return with the funds retained by the cashier or a friend of the cashier without returning the items associated with the transaction, etc.

Existing techniques for catching cashier fraud are not effective. These techniques typically do not consider the sequence of the transactions; but rather rely on abnormal totals associated with the cashiers, such as total associated with overuse of an employee's discount, high price overrides, excessive voids, etc.). The fraud is pinpointed by identifying out-of-ordinary transactions or by aggregating the cashier's abnormal totals of some time frame (a day, a week, or a month) and comparing a given cashier's total against an average of the totals for other cashiers during the same time frame.

The problem with existing techniques is that each independent cashier action (void, overrider, etc.) may in fact be legitimate while a sequence of such activities may more reliably identify a given fraudulent transaction.

For example, opening a Point-Of-Sale (POS) terminal drawer outside of a transaction, could be a valid action for exchanging notes. This type of cashier action is common along with transaction voids, both of which are frequent events that regularly occur at each POS terminal of a retailer. Thus, because activities associated with each transaction in isolation may in fact be legitimate, aggregating totals for these activities over time does not substantially enable fraud detection.

Thus, current techniques cannot effectively capture fraud especially fraud associated with the sequence of events detected during a single transaction performed by a cashier.

### SUMMARY

In various embodiments, system and a method for modeling transaction sequences for fraud detection are presented.

According to an aspect, a method for modeling transaction sequences for fraud detection is presented. Event associated with a transaction at a transaction terminal are received. A non-fraud score is calculated for the transaction based on probabilities assigned to transitions between the events and representing a likelihood of a sequence defined by the events for the transaction being non-fraudulent. The non-fraud score is provided to a fraud detection system for further fraud evaluation.

### BRIEF DESCRIPTION OF THE DRAWINGS

FIG. 1 is a diagram of a system for modeling transaction sequences for fraud detection, according to an example embodiment.

FIG. 2 is a diagram of a method for modeling transaction sequences for fraud detection, according to an example embodiment.

FIG. 3 is a diagram of another method for modeling transaction sequences for fraud detection, according to an example embodiment.

### DETAILED DESCRIPTION

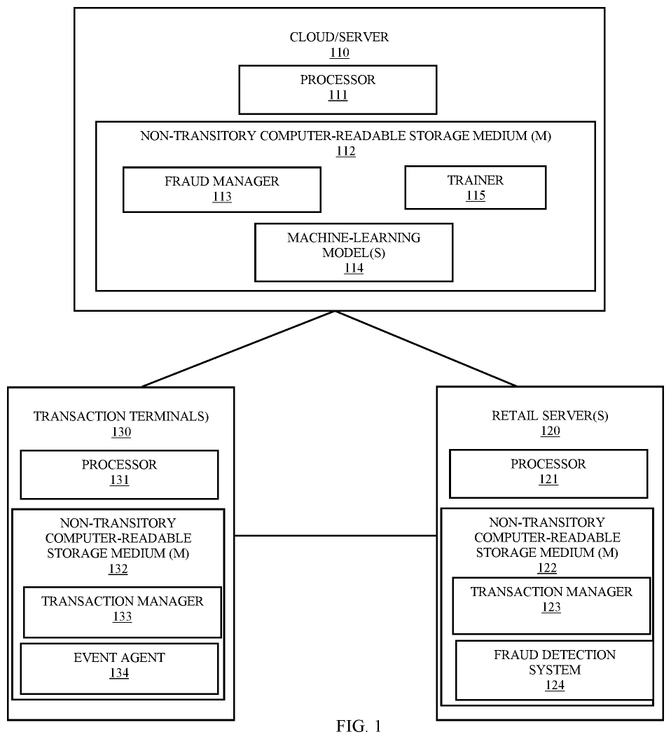

FIG. 1 is a diagram of a system 100 for modeling transaction sequences for fraud detection, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of modeling transaction sequences for fraud detection presented herein and below.

As will be discussed in the various embodiments that follow, the teachings provide techniques by which the sequences of transactions are modeled. The model identifies available states for a transaction and probabilities from moving from each given state to a next available state during the transaction. Within the model each available next state from which a given state can transition is assigned a probability associated with moving from the given state to a corresponding next state. As the transaction transitions from state to state, the probabilities are multiplied, such that when the transaction ends, the transaction as a whole is represented as a likelihood of non-fraud score (sum of the probabilities of actual state transitions). The lower the non-fraud score, the more likely the transaction was associated with fraud by the cashier. A risky sequence of state transitions (lower non-fraud score) during a transaction is significantly less common than a non-risky sequence (higher non-fraud score) of state transitions during a transaction. For example, opening a cash drawer (a state identified by an event) occurs with a frequency of 1 for each of 10,000 sales transactions but a drawer opening that followed a voided transaction (another state identified by another event) happens extremely rarely.

Each type of transaction is modeled, the types of transactions comprise sales, returns, voids, suspended, etc.

Transaction event logs are evaluated when producing the models for the transaction types. Each model comprises a state graph, the vertex representing the transaction type being modeled, nodes of the graph represent the states (which can be mapped to events from the event logs), and the edges connecting the nodes represent a transition from one state to another state. The probabilities for transitioning between each state is optimized according to observed cashier sequences in the transaction event logs, thus frequent transaction receive higher probabilities than others. Once a cashier sequence has been optimized, whether it is an observed one or a new one (according to which graph has been constructed or not), the sequence can be traced back on the graph and its non-fraud score (likelihood) can be computed.

Transactions executed during a configured time frame (such as a week) and was preprocessed based on domain knowledge associated with a given retailer. Firstly, this domain knowledge was preprocessed to remove transactions associated with an invalid login attempt, password change, incorrect username (e.g., cashier identifier); and terminal lock (terminal momentarily idle for inactivity) and terminal unlock modes, since the events/states associated with these types of situations occur very frequently and could skew the data. Secondly, sales transactions (a type of transaction) were broken down into two sub-types within the sale transaction type to account for low item count transactions and high item count transactions, since the probabilities of state transactions within these two sub-types correlate differently. Thirdly, transactions that are put on hold (suspended) and later recalled were combined in one state graph because a suspended transaction is uninformative without its recalled transaction, to wit, without knowing whether the transaction was ultimately paid for or voided; such transactions were combined into a single state or linked within the states' graph.

The states' graph can be represented by a Probabilistic Graphical Model (PGM), a recurrent Neural Network (NN), or any other algorithm that can process a series and emit a single non-fraud score for a provided transaction (represented by the state transitions (event transitions)). In an embodiment, a Hidden Markov Model (HMM) was implemented as a statistical model that assumes a Markov Process over time, i.e., that the likelihood of a state Y depends only on the preceding state X. Thus, when computing the HMM, a states' graph is generated, such that each state may emit one of the observations in the sequence with the inferred probability. For example, in one state a sales transaction may be emitted with a probability of 0.99 while in another state, where a return transaction is more probable (0.6), a sales transaction may be emitted with probability of 0.2. In addition, the probability to move from one state to another state is computed. Eventually, when the model is constructed, a new sequence of events for a new transaction as well as the transitions between the events (states) can be run across the graph to compute the probabilities of the sequence of events as well as the transitions between them, which in turn could be used to calculate the likelihood function for a cashier's activity for the new transaction. The HMM is trained over numerous historical cashiers' sequences. To gain optimal inference, thousands of sequences are processed, and the number of states in the states' graph, along with the transaction and emission probabilities are optimized. If a given cashier's sequence is prevalent, it is probably highly likely compared to sequences of other cashiers and therefore will receive a high non-fraud score (likelihood score), whereas a rare sequence will gain an exceptionally low non-fraud score (likelihood score) and could indicate a cashier that is putting the retailer at risk with fraud.

The resulting non-fraud score (likelihood score) can be combined with or used to augment existing techniques used by the retailer to identify cashier fraud. For example, a given cashier's non-fraud score can be evaluated in view of transaction totals maintained for the cashier to compute an overall fraud score that accounts both for transaction totals (voids, receipt reprints, price changes, etc.) over a configured period of time and non-fraud scores over the same period of time. This can help pinpoint specific transactions performed by a given cashier that require further auditing for potential fraud.

Moreover, threshold values may be set by a retailer for a given transaction, such that an alert can be raised in real time for a transaction that has an extremely low non-fraud score, which falls below the retailer-set threshold. A manager may be dispatched based on the alert to perform a real-time audit of the suspicious transaction.

Thus, system 100 and the techniques that follow evaluate the sequences of transactions for scoring the sequences of each transaction with a non-fraud score. The non-fraud score can be integrated into a retailer's existing fraud detection capabilities and/or used in real time for purposes of providing a contextual based fraud assessment on a per cashier and per transaction basis.

It is within this context system 100 is discussed.

System 100 comprises a cloud/server 110, a plurality of transaction terminals 130, and one or more retail servers 120.

Cloud/Server 110 comprises at least one processor 111 and a non-transitory computer-readable storage medium 112. Medium 112 comprises executable instructions for a fraud manager 113, one or more machine-learning models (algorithms) 114, and a trainer 115. The executable instructions when executed by processor 111 from the medium 112 cause processor 111 to perform operations discussed herein and below with fraud manager 113, model(s) 114, and trainer 114.

Each transaction terminal 120 comprises a processor 121 and a non-transitory computer-readable storage medium 122. Medium 122 comprises executable instructions for a transaction manager 123 and an event agent 124. The executable instructions when executed by processor 121 from medium 122 cause processor 121 to perform operations discussed herein and below with respect to transaction manager 123 and event agent 124.

Each retail server 130 comprises a processor 131 and a non-transitory computer-readable storage medium 132. Medium 132 comprises executable instructions for a transaction manager 133 and fraud detection system 134. The executable instructions when executed by processor 131 from medium 132 cause processor 131 to perform operations discussed herein and below with respect to transaction manager 133 and fraud detection system 134.

Initial training of model 113 is based on an event logs for each cashier (terminal operator who performs checkouts of customers within a store of a given retailer). During training transaction types are identified for each transaction's events. Each event representing a state transitioned to during a given transaction.

Trainer 115 provides preprocesses and labels event information from the invent log to model 114 to identify the cashier, weed/filter out events associated with login failures, provide a transaction type, provide any sub-transaction type (high item counts versus low item counts), and combine transaction suspension events with the corresponding recall events. The preprocessed data and events are provided as input to model 114. Model 114 receives all of the training data and then calculates by transaction type and by event or state a probability for each next state that the state can transition to. Each set of events per transaction is then assigned a non-fraud score based on the actual sequence of events/states for that transaction.

In an embodiment, model 114 is an HMM that infers the states and the transitions from the training data.

Once trained, model 114 can be provided events of a transaction, calculate probabilities associated with transitioning between each state that was traversed during the transaction and provide as output a non-fraud score (likelihood score).

After training of model 114, system 100 may operate as follows. A given cashier performs a transaction on terminal 130. Even agent 134 provides the events in real time to fraud manager 113 after the transaction completes. Fraud manager 113 inspects the events and preprocesses to remove invalid logins, identify the transaction type, identify any sub transaction type, identify the cashier identifier, terminal identifier, combine any suspended states with recall states, and fraud manager 113 provides the preprocessed data and events directly to model 114 as input. Model 114 returns a non-fraud or likelihood score. Fraud manager 113 may evaluate the fraud score against any retailer set threshold(s) and raise an alert to fraud detection system. Assuming no alert is raised, the non-fraud score for the cashier and the transaction is provided to fraud detection system 124 for inclusion in a fraud profile associated with the cashier. Fraud detection system 124 may combine abnormal transaction totals for the cashier with the non-fraud scores for all transactions of the cashier within the fraud profile. Fraud detection system 124 may also evaluate in real time the received non-fraud score for the current transaction against the current abnormal transaction totals for the cashier and based on rules determine whether the cashier should be monitored more closely or visited in real time for an audit of the transaction that most recently completed.

Transaction manager 133 interacts with transaction manager 123 to perform transaction processing, such as item lookups, item pricing, item discounts, loyalty processing, payment processing, returns, etc.

Model 144 self trains and adjusts itself over time as more transactions and events/states and frequencies of state transitions are noted, such that is no need to undergo a comprehensive training following the initial training. Thus, system 100 is self-learning, adaptable, and self-sustaining following the initial training session.

In an embodiment, event agent 134 obtains the events for a given transaction from an event log and reports the events for the transaction to fraud manager 113.

In an embodiment, event agent 134 monitors transaction processing by transaction manager 133 and accumulates the events in sequential order and reports the set of events when a transaction complete event is detected from transaction manager 133.

In an embodiment, transaction terminal 130 is a Point-Of-Sale (POS) terminal, a Self-Service Terminal (SST), or a kiosk.

In an embodiment, system 100 processes to provide a non-fraud score for customer self-checkouts on an SST 130. Here, model 114 may be trained on self-service transactions on events associated with self-directed transactions (for example, no cash drawer open events and other events that are available when trained on the cashiers).

In an embodiment, fraud manager 113, model 114, and trainer 115 may be subsumed into and executed on retailer server 120.

In an embodiment, transaction manager 123 and/or fraud detection system 124 may be subsumed into and executed on cloud/server 110.

In an embodiment, fraud manager 113, model 114, and trainer 115 is provides as a Software as a Service (SaaS) to a given retailer.

In an embodiment, fraud manager 113 can be run in a batch mode at the end of each data or other preconfigured interval of time, in which the event logs for the interval of time are provided and the non-fraud scores for each transaction during the interval returned back to fraud detection system 124. Fraud detection system 124 may link identified fraudulent transactions of a given retailer to video clips of security video for visually auditing suspect transactions.

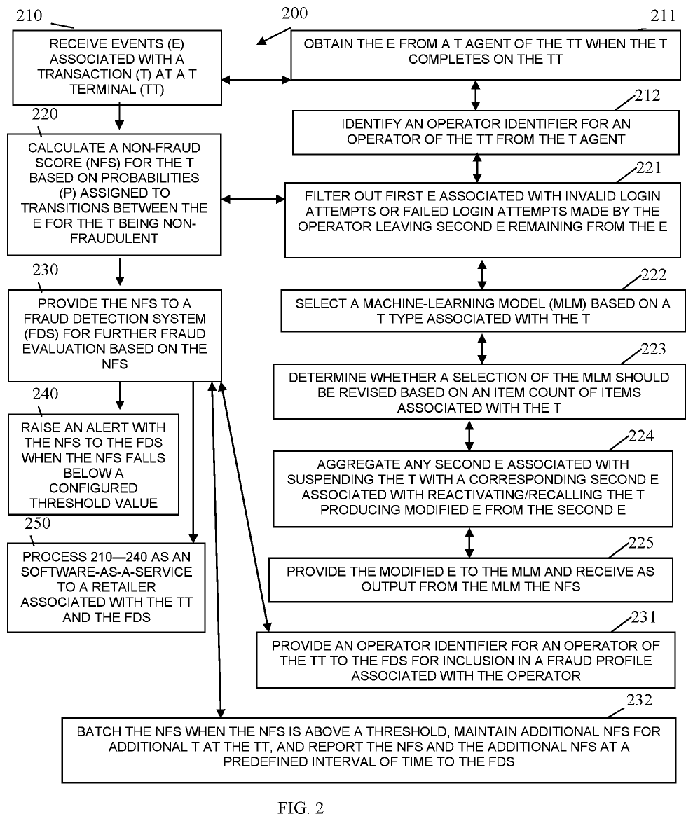

The above-referenced embodiments and other embodiments are now discussed with reference to FIG. 2.

FIG. 2 is a diagram of a method 200 for modeling transaction sequences for fraud detection, according to an example embodiment. The software module(s) that implements the method 200 is referred to as a “transaction sequence fraud assessor.” The transaction sequence fraud assessor is implemented as executable instructions programmed and residing within memory and/or a non-transitory computer-readable (processor-readable) storage medium and executed by one or more processors of one or more devices. The processor(s) of the device(s) that executes the transaction sequence fraud assessor are specifically configured and programmed to process the transaction sequence fraud assessor. The transaction sequence fraud assessor has access to one or more network connections during its processing. The connections can be wired, wireless, or a combination of wired and wireless.

In an embodiment, the device that executes the transaction sequence fraud assessor is cloud 110. In an embodiment, the device that executes transaction sequence fraud assessor is server 110.

In an embodiment, the transaction sequence fraud assessor is all of, or some combination of fraud manager 113, models 114, and/or trainer 115.

At 210, transaction sequence fraud assessor receives events associated with a transaction being processed or that was processed on a transaction terminal 130.

In an embodiment, at 211, the transaction sequence fraud assessor obtains the events from a transaction agent 134 of the transaction terminal 130 when the transaction completes on the transaction terminal 130.

In an embodiment of 211 and at 212, the transaction sequence fraud assessor identifies an operator identifier for an operator of the transaction terminal 130 from the transaction agent 134.

At 220, the transaction sequence fraud assessor calculates a non-fraud score for the transaction based on probabilities assigned to transitions between the events for the transaction being non-fraudulent when considered as a whole (the whole sequence of transitions between events or states of the transaction).

In an embodiment of 212 and 220, at 221, the transaction sequence fraud assessor filters out first events associated with invalid login attempts or failed login attempts made by the operator leaving second events remaining from the events.

In an embodiment of 221 and at 222, the transaction sequence fraud assessor selects a machine-learning model 114 based on a transaction type associated with the transaction.

In an embodiment of 222 and at 223, the transaction sequence fraud assessor determines whether a selection of the model 114 should be revised based on an item count of items associated with the transaction (low item counts for the transaction or high item counts for the transaction).

In an embodiment of 223 and at 224, the transaction sequence fraud assessor aggregates any second events associated with suspending the transaction with a corresponding second event associated with reactivating/recalling the transaction producing modified events from the second events.

In an embodiment of 224 and at 225, the transaction sequence fraud assessor provides the modified events to the model 114 and receives as output from the model 114 the non-fraud score.

At 230, the transaction sequence fraud assessor provides the non-fraud score to a fraud detection system 124 for further fraud evaluation based on the non-fraud score.

In an embodiment, at 231, the transaction sequence fraud assessor provides an operator identifier for an operator of the transaction terminal to the fraud detection system 124 for inclusion in a fraud profile associated with the operator.

In an embodiment, at 232, the transaction sequence fraud assessor batches the non-fraud score when the non-fraud score is above a threshold value. The transaction sequence fraud assessor further maintains additional non-fraud scores for additional transactions at the transaction terminal and reports the non-fraud scores and the additional non-fraud scores at a predefined interval of time to the fraud detection system 124.

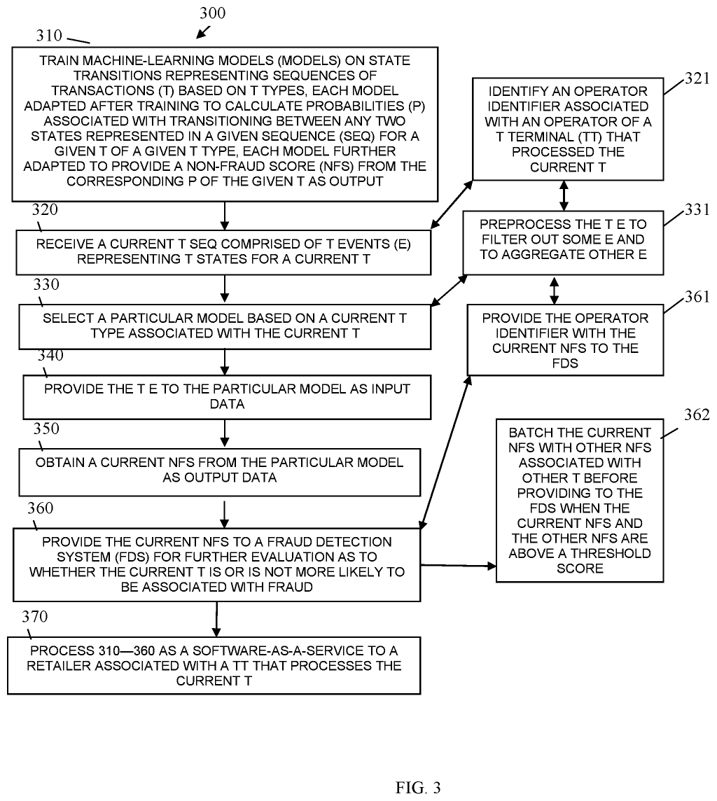

FIG. 3 is a diagram of another method 300 for modeling transaction sequences for fraud detection, according to an example embodiment. The software module(s) that implements the method 300 is referred to as a “transaction sequence-based fraud scorer.” The transaction sequence-based fraud scorer is implemented as executable instructions programmed and residing within memory and/or a non-transitory computer-readable (processor-readable) storage medium and executed by one or more processors of one or more devices. The processor(s) of the device(s) that executes the transaction sequence-based fraud scorer are specifically configured and programmed to process the transaction sequence-based fraud scorer. The transaction sequence-based fraud scorer has access to one or more network connections during its processing. The network connections can be wired, wireless, or a combination of wired and wireless.

In an embodiment, the device that executes the transaction sequence-based fraud scorer is cloud 110. In an embodiment, the device that executes the transaction sequence-based fraud scorer is server 110.

In an embodiment, the transaction sequence-based fraud scorer is all of, or some combination of fraud manager 113, models 114, trainer 115, and/or method 200.

The transaction sequence-based fraud scorer presents another and, in some ways, enhanced processing perspective from that which was discussed above with the method 200 of the FIG. 2.

At 310, the transaction sequence-based fraud scorer trains a plurality of machine-learning models 114 on state transitions representing sequences of transactions based on transaction types. Each model 114 adapted after training to calculate probabilities associated with transitioning between any two states represented in a given sequence for a given transaction of a given transaction type. Moreover, each model 114 is further adapted to provide a non-fraud score from the corresponding probabilities of the given transaction as output.

At 320, the transaction sequence-based fraud scorer receives a current transaction sequence comprised of transaction events representing transaction states for a current transaction.

In an embodiment, at 321, the transaction sequence-based fraud scorer identifies an operator identifier associated with an operator of a transaction terminal 130 that processed the current transaction.

At 330, the transaction sequence-based fraud scorer selects a particular model 114 based on a current transaction type associated with the current transaction.

In an embodiment of 321 and 330, at 331, the transaction sequence-based fraud scorer preprocesses the transaction events to filter out some events and to aggregate other events.

At 340, the transaction sequence-based fraud scorer provides the transaction events to the particular model 114 as input data.

At 350, the transaction sequence-based fraud scorer obtains a current non-fraud score from the particular model 114 as output data.

At 360, the transaction sequence-based fraud scorer provides the current non-fraud score to a fraud detection system 124 for further evaluation as to whether the current transaction is or is not more likely to be associated with fraud.

In an embodiment of 331 and 360, at 361, the transaction sequence-based fraud scorer provides the operator identifier for the operator with the current non-fraud score to the fraud detection system 124.

In an embodiment, at 362, the transaction sequence-based fraud scorer batches the non-fraud score with other non-fraud scores associated with other transactions before providing the non-fraud score to the fraud detection system 124 when the current non-fraud score and the other non-fraud scores are above a threshold score.

In an embodiment, the transaction sequence-based fraud scorer (method 300) is processes as a SaaS to a retailer associated with the transaction terminal 130 that processed the current transaction.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving events associated with a transaction at a transaction terminal;
calculating a non-fraud score for the transaction based on probabilities assigned to transitions between the events and representing a likelihood of a sequence defined by the events for the transaction being non-fraudulent; and
providing the non-fraud score to a fraud detection system for further fraud evaluation based on the non-fraud score.

2. The method of claim 1 further comprising, raising an alert with the non-fraud score to the fraud detection system when the non-fraud score falls below a configured threshold value.

3. The method of claim 1 further comprising, processing the method as a Software-as-a-Service (SaaS) to a retailer associated with the transaction terminal and the fraud detection system.

4. The method of claim 1, wherein receiving further includes obtaining the events from a transaction agent of the transaction terminal when the transaction completes on the transaction terminal.

5. The method of claim 4, wherein obtaining further includes identifying an operator identifier for an operator of the transaction terminal from the transaction agent.

6. The method of claim 5, wherein calculating further includes filtering out first events associated with invalid login attempts or failed login attempts made by the operator leaving second events remaining from the events.

7. The method of claim 6, wherein filtering further includes selecting a machine-learning model based on a transaction type associated with the transaction.

8. The method of claim 7 further comprising, determining whether a selection of the machine-learning model should be revised based on an item count or items associated with the transaction.

9. The method of claim 8, wherein determining further includes aggregating any second event associated with suspending the transaction with a corresponding second event associated with reactivating/recalling the transaction producing modified events from the second events.

10. The method of claim 9 further comprising, providing the modified events as input to the machine-learning model and receiving as output from the machine-learning model the non-fraud score.

11. The method of claim 1, wherein providing further includes providing an operator identifier for an operator of the transaction terminal to the fraud detection system for inclusion in a fraud profile associated with the operator.

12. The method of claim 1, wherein providing further includes batching the fraud detection score when the fraud detection score is above a threshold, maintaining additional fraud detection scores for additional transactions at the transaction terminal, and reporting the fraud detection score and the additional fraud detection scores at a predefined interval of time to the fraud detection system.

13. A method, comprising:
training machine-learning models on state transitions representing sequences of transactions based on transaction types, each machine-learning model adapted after training to calculate probabilities associated with transitioning between any two states represented in a given sequence for a given transaction of a given transaction type, each machine-learning model further adapted to provide a non-fraud score from the corresponding probabilities of the given transaction as output;
receiving a current transaction sequence comprised of transaction events representing transaction states for a current transaction;
selecting a particular machine-learning model based on a current transaction type associated with the current transaction;
providing the transaction events to the particular machine-learning model as input data;
obtaining a current non-fraud score from the particular machine-learning model as output data; and
providing the current non-fraud score to a fraud detection system for further evaluation as to whether the current transaction is or is not more likely to be associated with fraud.

14. The method of claim 13, wherein receiving further includes identifying an operator identifier associated with an operator of a transaction terminal that processed the current transaction.

15. The method of claim 14, wherein providing the transaction events further includes preprocessing the transaction events to filter out some events and to aggregate other events.

16. The method of claim 15, wherein providing the current non-fraud score further includes providing the operator identifier with the current non-fraud score to the fraud detection system.

17. The method of claim 13, wherein providing the current non-fraud score batching the current non-fraud score with other non-fraud scores associated with other transactions before providing to the fraud detection system when the current non-fraud score and the other non-fraud scores are above a threshold score.

18. The method of claim 13 further comprising, processing the method as a Software-as-a-Service (SaaS) to a retailer associated with a transaction terminal that processes the current transaction.

19. A system, comprising:
a cloud server comprising at least one processor and a non-transitory computer-readable storage medium;
the non-transitory computer-readable storage medium comprises executable instructions;
the executable instructions when provided to and executed by the at least one processor from the non-transitory computer-readable storage medium cause the at least one processor to perform operations comprising:
receiving a transaction sequence of events for a transaction processed on a transaction terminal;
selecting a trained machine-learning model based on a transaction type associated with the transaction;
filtering select events producing second events;
aggregating select additional events producing third events;
providing the third events to the trained machine-learning model as input;
receiving as output from the trained machine-learning model a non-fraud score that is based on probabilities of transitions between the third events within the transaction sequence of the transaction; and
providing the non-fraud score to a fraud detection system for further evaluation of any fraud that may be associated with the transaction.

20. The system of claim 19, wherein the executable instructions are accessible as a Software-as-a-Service (SaaS) to a retailer server associated with a retailer of the transaction terminal that processes the transaction.
